(19) United States
(12) Patent Application Publication
(10) Pub. No.: US 2026/0164312 A1
(43) Pub. Date: Jun. 11, 2026

(54) BIT RATE MANAGEMENT IN CELLULAR COMMUNICATION NETWORKS

(71) Applicant: Nokia Technologies Oy, Espoo (FI)

(72) Inventors: Philippe GODIN, Versailles (FR); Alessio CASATI, West Molesey Surrey (GB)

(21) Appl. No.: 18/722,186

(22) PCT Filed: Dec. 13, 2022
(86) PCT No.: PCT/EP2022/085481

§ 371 Date: Jun. 20, 2024

(30) Foreign Application Priority Data
Dec. 22, 2021 (FI) 20216321

(51) Int. Cl. H04W 28/22; H04L 47/20

(52) U.S. Cl. CPC H04W 28/22; H04L 47/20

(57) ABSTRACT

An apparatus including means for transmitting, to a distributed unit, a first request to restrict uplink traffic of a slice for a user equipment, means for receiving from the distributed unit a notification indicating a failure in restricting the uplink traffic of the slice for the user equipment according to the first request and means for transmitting, responsive to said reception, a second request to restrict the uplink traffic of the slice for the user equipment to at least one central unit user plane.

### FIELD

Various example embodiments relate in general to cellular communication networks and more specifically, to bit rate management in such networks.

### BACKGROUND

Bit rate management is important in various wireless communication networks, such as, in cellular networks operating according to Long Term Evolution, LTE, and/or 5G radio access technology. 5G radio access technology may also be referred to as New Radio, NR, access technology. Since its inception, LTE has been widely deployed and 3rd Generation Partnership Project, 3GPP, still develops LTE. Similarly, 3GPP also develops standards for 5G/NR. In general, there is a need to provide methods, apparatuses and computer programs for improving bit rate management in cellular communication networks, e.g., when Central Units, CUs, and Distributed Units, DUs, are in use. Such improvements may be exploited for 5G networks and also for other cellular communication networks in the future as well.

### SUMMARY

According to some aspects, there is provided the subject-matter of the independent claims. Some example embodiments are defined in the dependent claims.

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to a first aspect of the present invention, there is provided an apparatus comprising means for transmitting, to a distributed unit, a first request to restrict uplink traffic of a slice for a user equipment, means for receiving from the distributed unit a notification indicating a failure in restricting the uplink traffic of the slice for the user equipment according to the first request and means for transmitting, responsive to said reception, a second request to restrict the uplink traffic of the slice for the user equipment to at least one central unit user plane. The apparatus of the first aspect may be configured to operate as a central unit control plane. The apparatus may be for example a network node or a control device configured to control the functioning of the network node.

Example embodiments of the first aspect may comprise at least one feature from the following bulleted list:
wherein the first request and/or the second request comprises an uplink maximum bit rate value of the slice for the user equipment;
wherein the uplink maximum bit rate value is an upper bound bit rate for all traffic of all radio bearers associated to protocol data unit sessions active for the slice for the user equipment;
wherein the uplink maximum bit rate value of the slice for the user equipment is transmitted in an F1 application protocol user equipment context setup or modification message message;
wherein the notification indicating a failure in restricting the uplink traffic of the slice for the user equipment is received in an F1 application protocol notify message;
wherein the notification indicating a failure in restricting the uplink traffic of the slice for the user equipment is received in an F1 application protocol response message responsive to the first request;
wherein the F1 application protocol response message is an F1 application protocol user equipment context setup or modification response message;
wherein the second request is transmitted in an E1 application protocol notify message;
wherein the second request is transmitted in a new, i.e., non-existing currently in the 3GPP standards, dedicated E1 application protocol message;
wherein the first request is transmitted in an F1 application protocol message;
wherein the request is transmitted in an F1 application protocol user equipment context setup or F1 application protocol user equipment context modification request;
wherein the second request to restrict the uplink traffic of the slice for the user equipment comprises an indication indicating a failure in restricting the uplink traffic of the slice for the user equipment in the distributed unit according to the first request;
wherein the second request is transmitted to multiple central unit user planes, and the apparatus further comprises means for transmitting to each of said multiple central unit user planes a second request to restrict uplink traffic of the slice of the user equipment to a share of an uplink maximum bit rate value of the slice of the user equipment, the share being a share of an uplink maximum bit rate value of the slice for the user equipment requested from the distributed unit.

According to a second aspect of the present invention, there is provided an apparatus comprising means for receiving, from a central unit control plane, a first request to restrict uplink traffic of a slice for a user equipment, means for detecting that the apparatus fails to restrict the uplink traffic of the slice for the user equipment according to the first request and means for transmitting to the central unit control plane, upon said detection, a notification indicating that the apparatus fails in restricting the uplink traffic of the slice for the user equipment according to the first request. The apparatus of the second aspect may be configured to operate as a distributed unit. The apparatus may be for example a network node or a control device configured to control the functioning of the network node.

Example embodiments of the second aspect may comprise at least one feature from the following bulleted list:
wherein the first request comprises an uplink maximum bit rate value of the slice for the user equipment;
wherein the uplink maximum bit rate value is an upper bound bit rate for all traffic of all radio bearers associated to protocol data unit sessions active for the slice of the user equipment;
wherein the uplink maximum bit rate value of the slice for the user equipment is received in an F1 application protocol user equipment context setup or modification message;
wherein the notification indicating a failure in restricting the uplink traffic of the slice for the user equipment is transmitted in an F1 application protocol notify message;
wherein the notification indicating a failure in restricting the uplink traffic of the slice for the user equipment is transmitted in an F1 application protocol response message responsive to the first request;
wherein the F1 application protocol response message is an F1 application protocol user equipment context setup or modification response message;
wherein the first request is received in an F1 application protocol message;
wherein the request is received in an F1 application protocol user equipment context setup or F1 application protocol user equipment context modification request;
wherein said means for transmitting comprises means for transmitting the notification using an F1 application protocol notify message;
wherein said means for transmitting comprises means for transmitting the notification within an F1 application protocol response message to the request, such as an F1 application protocol user equipment context response message;
wherein said means for detecting further comprises means for detecting that the apparatus fails to restrict uplink traffic of the slice for the user equipment according to an uplink maximum bit rate value of the slice for the user equipment;
wherein said means for detecting further comprises detecting that the apparatus is unable to apply logical channel restrictions or logical channel group configurations associated with the radio bearers of the slice;
wherein the apparatus failing to restrict uplink traffic results from the inability to apply appropriate logical channel restrictions or logical channel group configurations associated with the radio bearers of the slice.

According to a third aspect, there is provided a first method comprising transmitting, to a distributed unit, a first request to restrict uplink traffic of a slice for a user equipment, receiving from the distributed unit, a notification indicating a failure in restricting the uplink traffic of the slice for the user equipment according to the first request and transmitting, responsive to said reception, a second request to restrict the uplink traffic of the slice for the user equipment to at least one central unit user plane. The first method may be performed a central unit control plane or an apparatus configured to operate as the central unit control plane, like a network node or control device of a control device configured to control the functioning of the network node.

According to a fourth aspect, there is provided a second method, comprising receiving, from a central unit control plane, a first request to restrict uplink traffic of a slice for a user equipment, detecting that an apparatus fails to restrict the uplink traffic of the slice for the user equipment according to the first request and transmitting to the central unit control plane, upon said detection, a notification indicating that the apparatus fails in restricting the uplink traffic of the slice for the user equipment according to the first request. The second method may be performed by a distributed unit or an apparatus configured to operate as the distributed unit, like a network node or control device of a control device configured to control the functioning of the network node

According to a fifth aspect of the present invention, there is provided an apparatus comprising at least one processing core, at least one memory including computer program code, the at least one memory and the computer program code being configured to, with the at least one processing core, cause the apparatus at least to perform, transmit, to a distributed unit, a first request to restrict uplink traffic of a slice for a user equipment, receive from the distributed unit a notification indicating a failure in restricting the uplink traffic of the slice for the user equipment according to the first request and transmit, responsive to said reception, a second request to restrict the uplink traffic of the slice for the user equipment to at least one central unit user plane. The apparatus of the fifth aspect may be configured to operate as a central unit control plane. The apparatus may be for example a network node or a control device configured to control the operation of the network node.

According to a sixth aspect of the present invention, there is provided an apparatus comprising at least one processing core, at least one memory including computer program code, the at least one memory and the computer program code being configured to, with the at least one processing core, cause the apparatus at least to perform, receive, from a central unit control plane, a first request to restrict uplink traffic of a slice for a user equipment, detect that the apparatus fails to restrict the uplink traffic of the slice for the user equipment according to the first request and transmit to the central unit control plane, upon said detection, a notification indicating that the apparatus fails in restricting the uplink traffic of the slice for the user equipment according to the first request. The apparatus of the sixth aspect may be configured to operate as a distributed unit. The apparatus may be for example a network node or a control device configured to control the operation of the network node.

According to a seventh aspect of the present invention, there is provided non-transitory computer readable medium having stored thereon a set of computer readable instructions that, when executed by at least one processor, cause an apparatus to at least perform the first method. According to an eighth aspect of the present invention, there is provided non-transitory computer readable medium having stored thereon a set of computer readable instructions that, when executed by at least one processor, cause an apparatus to at least perform the second method.

According to a ninth aspect of the present invention, there is provided a computer program configured to perform the first method. According to a tenth aspect of the present invention, there is provided a computer program configured to perform the second method.

### BRIEF DESCRIPTION OF THE DRAWINGS

FIG. 1 illustrates a network scenario in accordance with at least some example embodiments;

FIG. 2 illustrates a base station in accordance with at least some example embodiments;

FIG. 3 illustrates a signalling graph in accordance with at least some example embodiments;

FIG. 4 illustrates an apparatus capable of supporting at least some example embodiments;

FIG. 5 illustrates a flow graph of a first method in accordance with at least some example embodiments;

FIG. 6 illustrates a flow graph of a second method in accordance with at least some example embodiments.

### EXAMPLE EMBODIMENTS

Bit rate management may be improved in a cellular communication network by the procedures described herein. More specifically, bit rate management may be improved when Central Units, CUs, and Distributed Units, DUs, are in use. A CU Control Plane, CP, may request a DU to restrict Uplink, UL, traffic of a slice for a User Equipment, UE. The DU may then detect that it cannot restrict the UL traffic to fulfil the request and if so, the DU may be triggered to transmit to the CU CP a notification indicating a failure in restricting the UL traffic. Upon receiving the notification, the CU CP may also ask at least one CU User Plane, UP, to restrict the UL traffic and the CU UP may do so, e.g., by dropping at least one packet of the UE. Bit rate management can be thus performed even if the DU would not be able to fulfil the requested restriction of the UL traffic.

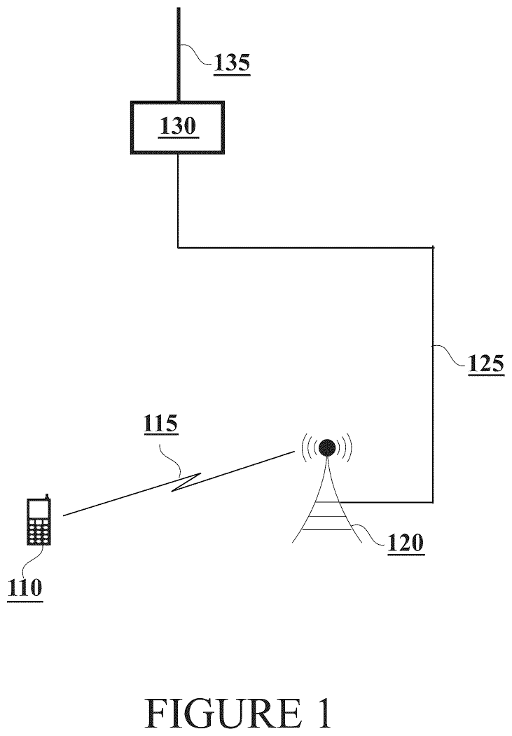

FIG. 1 illustrates an exemplary network scenario in accordance with at least some example embodiments. According to the example scenario of FIG. 1, there may be a cellular communication network, which comprises UE 110, Base Station, BS, 120, and core network element 130. In general, BS 120 may be referred to as a Radio Access Network, RAN, node as well.

UE 110 may comprise, for example, a smartphone, a cellular phone, a Machine-to-Machine, M2M, node, Machine-Type Communications node, MTC, an Internet of Things, IoT, node, a car telemetry unit, a laptop computer, a tablet computer or, indeed, any suitable UE or mobile station. In the example system of FIG. 1, UE 110 may communicate wirelessly with BS 120, or with a cell of BS 120, via air interface 115. In some example embodiments, BS 120 may be considered as a serving BS, for UE 110.

UE 110 may be connected to BS 120 via air interface 115. Air interface 115 between UE 110 and BS 120 may be configured in accordance with a Radio Access Technology, RAT, which UE 110 and BS 120 are configured to support. Examples of cellular RATs include Long Term Evolution, LTE, New Radio, NR, which may also be known as fifth generation, 5G, radio access technology and MulteFire. For example, in the context of LTE, BS 120 may be referred to as eNB while in the context of NR, BS 120 may be referred to as gNB. In any case, example embodiments are not restricted to any particular wireless technology.

BS 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. BS 120 may be connected with at least one other BS as well via an inter-base station interface (not shown in FIG. 1), even though in some example embodiments the inter-base station interface may be absent. BS 120 may be connected, directly or via at least one intermediate node, with core network 130 or with another core network.

In some example embodiments, BS 120 may further comprise a DU and at least one CU. However, in some example embodiments, the DU and the CU(s) may be located in separate parts of the network, i.e., in separate network elements/nodes. For instance, the DU may be located in BS 120 while the CU may be located in core network 130. One DU may be connected to multiple CUs, via F1 interfaces for example. On the other hand, one CU may be connected to multiple DUs, possibly via said F1 interfaces as well. The DU may be responsible for handling layers from the physical layer to the Radio Link Control, RLC, layer, while the at least one CU may be responsible for handling the Packet Data Convergence Protocol, PDCP, layer and layers above the PDCP layer such as SDAP layer. That is to say, the CU-DU split may be done, e.g., between the RLC and the PDCP layer.

The CU may be a logical node and it may perform some functions of a BS, such as, for example, transfer of user data, mobility control, RAN sharing and session management. In some example embodiments, the CU may be referred to as a Baseband Unit, BBU, for example. Moreover, the DU may be a logical node as well. The DU may also perform some, i.e., a subset of, functions of a BS. In some example embodiments, the DU may be referred to as a Remote Radio Head, RRH, for example. That is to say, functions of a base station may be split between a DU and a CU.

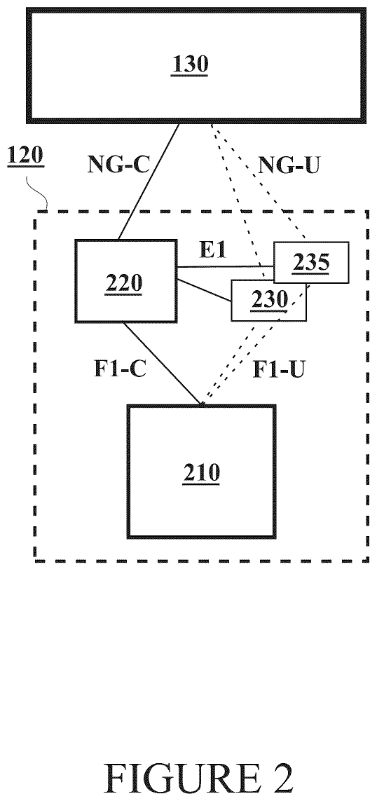

FIG. 2 illustrates a base station in accordance with at least some example embodiments. More specifically, FIG. 2 illustrates a BS, such as a gNB, with an architecture in which DU 210 may be connected to CU CP 220 via an interface, such as F1-C interface. DU 210 may also be connected to first CU UP 230 and second CU UP 235 via different interface, such as F1-U interfaces. In the example of FIG. 2, CU CP 220 may be further connected to core network 130 via an interface, such as NG-C interface. In addition, first CU UP 230 and second CU UP 235 may be connected to core network 130 via different interfaces, such as NG-U interfaces. In some example embodiments, CU CP 220 along with first CU UP 230 and second CU UP 235 may be located in core network 130 though.

UE Slice Maximum Bit Rate, SMBR, value may refer to a maximum bit rate value of a slice for UE 110 shown in FIG. 1. In some example embodiments, UE SMBR enforcement may refer to restricting the traffic up to a UE SMBR value and be performed in the RAN or in a Policy Control Function, PCF. To enable restriction in the RAN, an Access and Mobility Function, AMF, may transmit a UE SMBR value of UE 110 to the RAN associated with a slice for UE 110. The UE SMBR value of UE 110 may be an upper bound bit rate for all the traffic of all radio bearers associated to Protocol Data Unit, PDU, sessions active for the slice of UE 110. In some example embodiments, the UE SMBR value may have a Downlink, DL, value, DL-SMBR, and an Uplink, UL, value, UL-SMBR.

The UL-SMBR may be assumed to be enforced in a BS, like BS 120 shown in FIG. 1, such as an gNB, through scheduling of UL traffic. The scheduler may be in DU 210 and in such a case the UL traffic restriction according to the UL-SMBR value may be performed by DU 210. CU CP 220 may decide to split one UL-SMBR value of UE 110 among the DU(s). The DUs may then enforce the respective DU UL-SMBR values as upper limits of UL traffic for UE 110.

In some example embodiments, there may be circumstances where BS 120, comprising DU 210, has received an UL-SMBR but the scheduler cannot enforce the received UL-SMBR, for example if the enforcement is only possible through a proper configuration of logical channel restrictions and logical channel group configurations associated with the radio bearers of the slice. Such a configuration may be difficult to achieve in some scenarios, e.g., if multiple slices are simultaneously used in BS 120 for UE 110. In general, enforcement may refer to an ability of the scheduler, i.e., DU 210, to restrict the UL traffic of a slice for UE 110 at the upper bound of SMBR value.

SMBR enforcement may be provided by configuring different resources per slice, but it may not be always possible in the scenarios mentioned above. If SMBR enforcement is not possible, the scheduler in DU 210 may not be able to fulfil the requested UL-SMBR restriction. That is, there may be a failure in restricting UL traffic of the slice for UE 110 by DU 210 according to the request of CU CP 220.

Embodiments of the present invention therefore provide a way to enhance bit rate management, in particular when CUs and DUs are in use, by enabling SMBR enforcement when DU 210 is unable to fulfil the requested UL-SMBR restriction. DU 210 may receive from CU CP 220 a first request to restrict UL traffic of a slice for UE 110. The first request may comprise an UL-SMBR value for UE 110. For instance, DU 210 may receive the UL-SMBR value of UE 110 from CU CP 220 to restrict the UL traffic of the slice for UE 110 at maximum to the UL-SMBR value.

Upon receiving the first request, DU 210 may detect that it fails to restrict the UL traffic of the slice for UE 110 according to the first request. If DU 220 detects that it fails to restrict the UL traffic of the slice for UE 110 according to the first request, i.e., that it is not able to fulfil the first request, DU 210 may transmit to CU CP 220 a notification indicating a failure of DU 210 in restricting the UL traffic of the slice of UE 110 according to the first request. For instance, DU 210 may transmit the notification indicating a failure in restricting the uplink traffic of the slice in an F1AP Notify message, e.g., an F1AP (control plane) notification, to CU CP 220 indicating that DU 210 cannot restrict the uplink slice traffic for UE 110 as requested.

In some example embodiments, DU 210 may transmit the notification in a new information element in an existing F1AP Notify message or in a new information element in a new F1AP message.

Responsive to receiving the notification, CU CP 220 may transmit a second request to restrict the UL traffic of the slice for UE 110 to at least one CU UP, like first CU UP 230 and/or second CU UP 235. That is, upon receiving the notification from DU 210 that DU 210 cannot restrict the slice traffic for UE 110 as requested, CU CP 220 may ask one or more CU UPs to restrict the traffic instead of DU 210.

In some example embodiments, the second request may comprise an indication indicating a failure in restricting the uplink traffic of the slice for UE 110 in DU 210 according to the first request. That is, when CU CP 220 asks at least one CU UP to restrict the slice traffic, CU CP 220 may include the reason to the second request, i.e., that DU 210 failed to restrict the slice traffic of UE 110.

The second request may comprise an UL-SMBR value for UE 110. For example, when CU CP 220 asks at least one CU UP to restrict the uplink slice traffic, CU CP 220 may include the UL-SMBR value of UE 110 to be used by the at least one CU UP to restrict the uplink traffic of the slice. If the second request is transmitted to one CU UP, the UL-SMBR value transmitted to the CU UP may be the same as the UL-SMBR value earlier transmitted to DU 210.

In some example embodiments, the second request may be transmitted to multiple CU UPs and the second request may comprise a request to restrict the UL traffic of the slice of UE 110 to a share of an UL-SMBR value for UE 110, the share being a share of an UL-SMBR value for UE 110 requested from DU 210. That is, if more than one CU UP(s) is asked to restrict the UL traffic of the slice of UE 110, CU CP 220 may transmit to one CU UP, like CU UP 230 or CU UP 235, only a calculated share of the UL-SMBR that DU 210 was earlier requested to restrict.

Alternatively, CU CP 220 may transmit the share of an UL-SMBR value of UE 110 before receiving the notification indicating the failure in restricting the UL traffic of the slice for UE 110 according to the first request. That is, the share may be transmitted earlier of the detecting that the second request needs to be transmitted to multiple CU UPs, in case a DU failure would happen. CU UP may store the information about the share and use the information to actually restrict the uplink traffic of the slice only if/when being asked, i.e., responsive to receiving the second request, by CU CP 220.

When requested to restrict the traffic, CU UP(s), like first CU UP 230 and/or CU UP 235, may use any method to slow down the bit rate, such discarding one or more packets of UE 110.

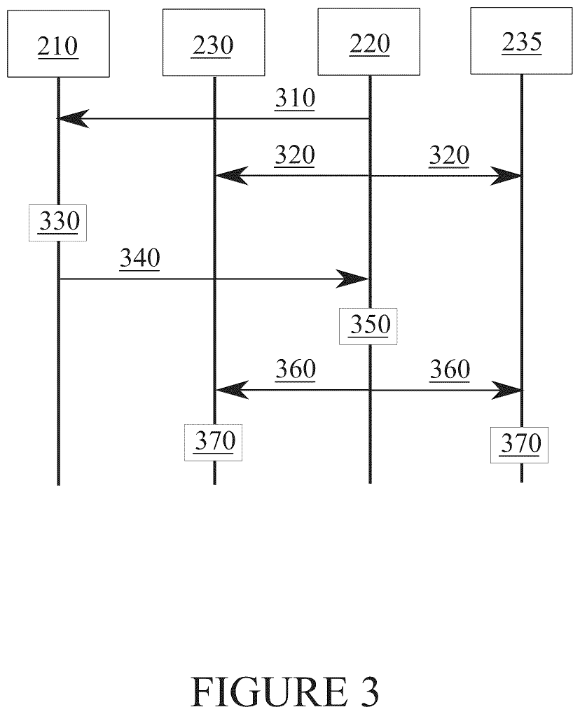

FIG. 3 illustrates an exemplary signalling graph in accordance with at least some embodiments. On the vertical axes are disposed, from the left to the right, DU 210, first CU UP 230, CU CP 220 and second CU UP 235 of FIG. 2. Time advances from the top toward the bottom.

At step 310, CU CP 220 may transmit to DU 210 a first request (e.g., F1AP UE context setup (DU1_UL_SMBR)) to restrict UL traffic of a slice for UE 110 shown in FIG. 1. The first request may be transmitted in an F1AP message. In some example embodiments, the first request may comprise an UL-SMBR value for UE 110, i.e., an UL MBR value of a slice for UE 110. The UL-SMBR value for UE 110 may be an upper bound bit rate for all traffic of all radio bearers associated with PDU sessions active for the slice of UE 110. Active PDU sessions may refer to sessions that are configured for UE 110 and in use. Thus, CU CP 220 may configure DU 210 with the UL-SMBR value for UE 110 and ask DU 210 to restrict the UL traffic for UE 110 accordingly for the slice in question. The UL-SMBR value for UE 110 may be transmitted to DU 210 in an F1AP UE context setup message.

At step 320, CU CP 220 may setup bearer contexts associated with the said radio bearers, e.g., by transmitting an E1AP bearer context setup message, between CU CP 220 and first CU UP 230. CU CP 220 may also setup bearer contexts between CU CP 220 and second CU UP 235 similarly.

At step 330, DU 210 may detect that it fails to restrict the UL traffic of the slice for UE 110 according to the first request (DU1_UL_SMBR). That is, DU 210 may detect that it cannot restrict the UL traffic of the slice for UE 110 according to the first request. For instance, DU 210 may detect that it fails to restrict the UL traffic due to its inability to apply logical channel restrictions or logical channel group configurations associated with radio bearers of the slice.

In some example embodiments, DU 210 may detect that it cannot restrict the UL traffic of the slice for UE 110 according to the UL-SMBR value for UE 110. That is, DU 210 may detect that it does not have the ability to restrict the UL traffic of the slice in question for UE 110 according to the first request, e.g., at the upper bound of the UL-SMBR for UE 110. Hence, at step 330 DU 210 may detect that it cannot or can no longer fulfil the first request received at step 310, i.e., DU 210 cannot enforce the UL-SMBR value for UE 110 as requested.

At step 340, DU 210 may transmit a notification (DU1_UL_SMBR fail) to CU CP 220, the notification indicating a failure in restricting the UL traffic of the slice for UE 110 according to the first request. That is, the notification may indicate that DU 210 cannot restrict the UL traffic of the slice for UE 110 according to the first request received at step 310. The notification may therefore indicate that DU 210 is not able to fulfil the first request. The notification may be transmitted responsive to said detection at step 330. That is, said detection may trigger DU 210 to transmit the notification to CU CP 220 to indicate that DU 210 cannot or can no longer fulfil the request received at step 310.

The notification may be transmitted in an F1AP notify message (e.g., DU1_UL_SMBR fail). Alternatively, the notification may be transmitted in an F1AP response message responsive to the first request. In some example embodiments, the F1AP response message may be an F1AP UE context setup response message.

At step 350, CU CP 220 may determine, based on the received notification, that DU 210 cannot or can no longer fulfil the first request received at step 310. That is, CU CP 220 may determine that DU 210 is not able to restrict the UL traffic of the slice for UE 110 and decide to ask first CU UP 230 and/or second CU CP 235 to restrict the UL traffic of the slice for UE 110 instead of DU 210. In some example embodiments, DU 210 may decide to ask first CU UP 230 and/or second CU CP 235 to restrict the UL traffic of the slice for UE 110 according to the UL-SMBR value of UE 110.

At step 360, CU CP 220 may transmit, responsive to reception of the notification at step 340, a second request to restrict the UL traffic of the slice for UE 110 to at least one CU UP, like first CU UP 230 and/or second CU CP 235. In some example embodiments, the second request may comprise the UL-SMBR value for UE 110. The second request may be transmitted in an E1AP message, e.g., in a new dedicated E1AP message or alternatively in an E1AP bearer modification request message. The second request to restrict the UL traffic of the slice for UE 110 may comprise an indication indicating a failure in restricting the UL traffic of the slice for UE 110. That is, the indication (e.g., E1AP Notify (DU1_UL_SMBR fail*, DU1_UL_SMBR/2*) may indicate that DU 210 cannot restrict the UL traffic of the slice of UE 110 according to the first request transmitted by CU CP 220 at step 310.

In some example embodiments, if the second request is transmitted to multiple CU UPs, the second request may also comprise a share of the UL-SMBR of the slice for UE 110 that CU CP 220, the share being a share of the UL MBR value of the slice for UE 110 that CU CP 220 requests first CU UP 230 and/or second CU UP 235 to restrict to. The share may be a share of the UL-SMBR value for UE 110 that was requested from DU 210, e.g., a half of the UL-SMBR value for UE 110 that was requested from DU 210 if the second request is transmitted to two CU UPs (DU1_UL_SMBR/2).

At step 370, first CU UP 230 and second CU UP 235, that receive the second request from CU CP 220, may restrict the UL traffic of the slice for UE 110 according to the second request. For instance, the CU UP(s) that receive the second request from CU CP 220 may drop packets so as to limit the uplink traffic of the slice to the share of the UL-SMBR value for UE 110. That is, first CU UP 230 and second CU UP 235 may restrict the UL traffic for UE 110 such that it does not exceed the share of the UL-SMBR value for UE 110.

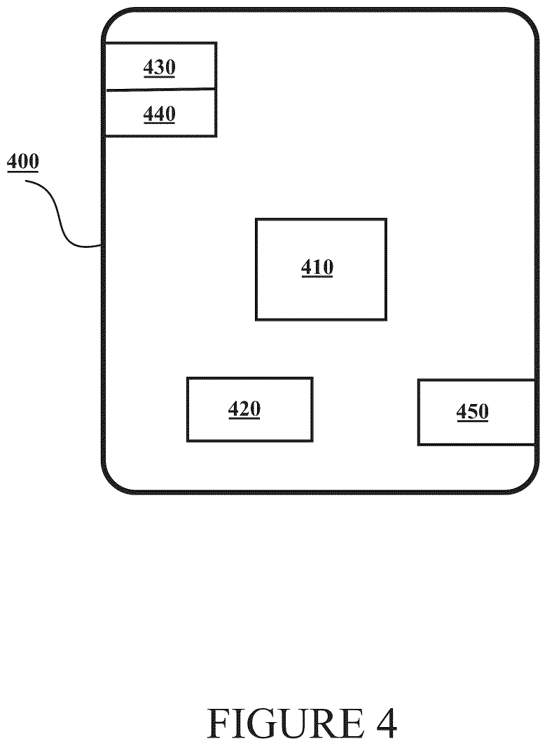

FIG. 4 illustrates an example apparatus capable of supporting at least some example embodiments. Illustrated is device 400, which may comprise, for example, DU 210 or CU CP 220, or a device controlling functioning thereof. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. Processor 410 may comprise at least one Application-Specific Integrated Circuit, ASIC. Processor 410 may comprise at least one Field-Programmable Gate Array, FPGA. Processor 410 may comprise an Intel Xeon processor for example. Processor 410 may be means for performing method steps in device 400, such as determining, causing transmitting and causing receiving. Processor 410 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a network function, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular standard, such as a standard defined by the 3rd Generation Partnership Project, 3GPP. Transmitter 430 may comprise more than one transmitter. Receiver 440 may comprise more than one receiver. Transmitter 430 and/or receiver 440 may be configured to operate in accordance with Global System for Mobile communication, GSM, Wideband Code Division Multiple Access, WCDMA, Long Term Evolution, LTE, and/or 5G standards, for example.

Device 400 may comprise User Interface, UI, 450. UI 450 may comprise at least one of a display, a keyboard, a touchscreen, a vibrator arranged to signal to a user by causing device 400 to vibrate, a speaker and a microphone. A user may be able to operate device 400 via UI 450, for example to configure device 400 and/or functions it runs.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. In some example embodiments, device 400 lacks at least one device described above. For example, device 400 may not have UI 450.

Processor 410, memory 420, transmitter 430, receiver 440 and/or UI 450 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the example embodiment various ways of interconnecting at least two of the aforementioned devices may be selected without departing from the scope of the present invention.

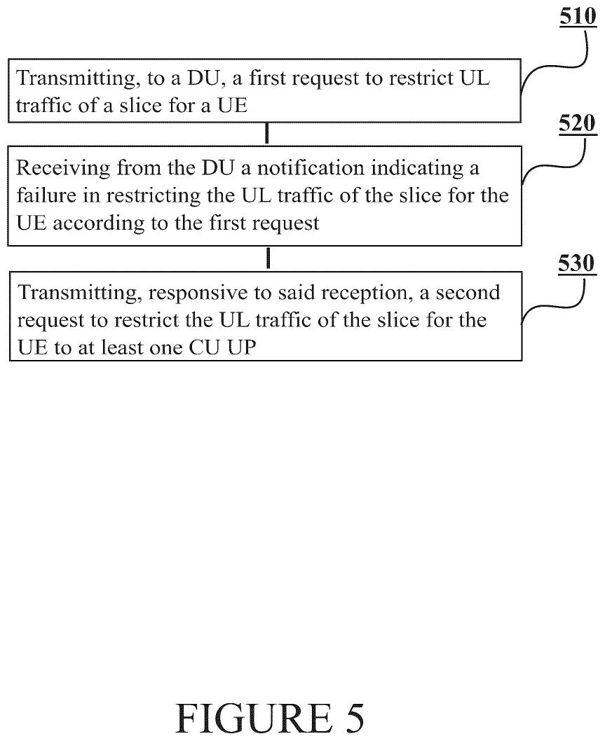

FIG. 5 is a flow graph of a first method in accordance with at least some example embodiments. The first method may be performed by CU CP 220, or an apparatus configured to operate as CU CP 220, like a network node or control device of a control device configured to control the functioning of the network node, possibly when installed in BS 120 or core network 130.

The first method may comprise, at step 510, transmitting, to a DU, a first request to restrict UL traffic of a slice for a UE. The first method may also comprise, at step 520, receiving from the DU, a notification indicating a failure in restricting the UL traffic of the slice for the UE according to the first request. Finally, the first method may comprise, at step 530, transmitting, responsive to said reception, a second request to restrict the UL traffic of the slice for the UE to at least one CU UP.

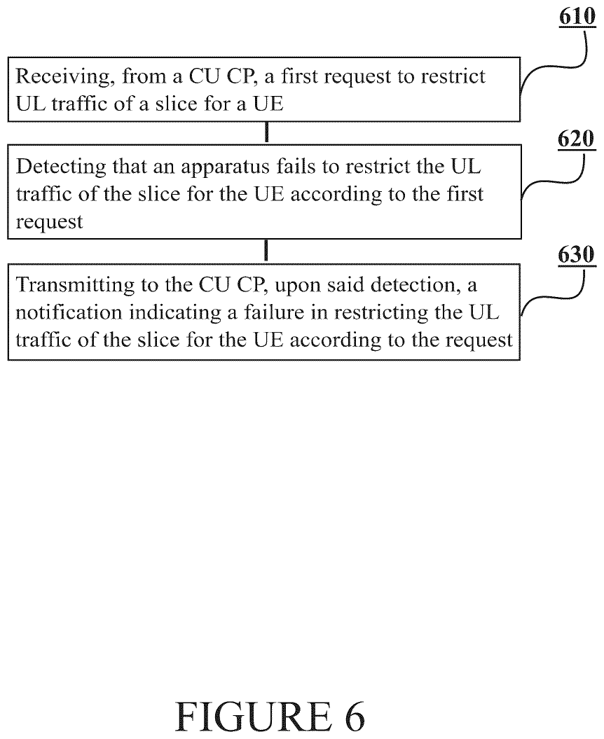

FIG. 6 is a flow graph of a second method in accordance with at least some example embodiments. The second method may be performed by DU 210, or an apparatus configured to operate as DU 210, or an apparatus configured to operate as DU 210, like a network node or control device of a control device configured to control the functioning of the network node, possibly when installed in BS 120.

The second method may comprise, at step 610, receiving, from a CU CP, a first request to restrict UL traffic of a slice for a UE. The second method may also comprise, at step 620, detecting that an apparatus fails to restrict the UL traffic of the slice for the UE according to the first request. Finally, the second method may comprise, at step 630, transmitting to the CU CP, upon said detection, a notification indicating that the apparatus fails in restricting the UL traffic of the slice for the UE according to the first request.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an exemplary example embodiment, an apparatus, such as, for example, DU 210 or CU CP 220, may comprise means for carrying out the example embodiments described above and any combination thereof.

In an exemplary example embodiment, a computer program may be configured to cause a method in accordance with the example embodiments described above and any combination thereof. In an exemplary example embodiment, a computer program product, embodied on a non-transitory computer readable medium, may be configured to control a processor to perform a process comprising the example embodiments described above and any combination thereof.

In an exemplary example embodiment, an apparatus, such as, for example, DU 210 or CU CP 220, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks.

ACRONYMS LIST

| | |
|---|---|
| 3GPP | 3rd Generation Partnership Project |
| AMF | Access and Mobility Function |
| BBU | Baseband Unit |
| BS | Base Station |
| CP | Control Plane |
| CU | Central Unit |
| DU | Distributed Unit |
| GSM | Global System for Mobile communication |
| IoT | Internet of Things |
| LTE | Long-Term Evolution |
| M2M | Machine-to-Machine |
| MAC | Media Access Control |
| NFC | Near-Field Communication |
| NR | New Radio |
| PCF | Policy Control Function |
| PDU | Protocol Data Unit |
| PLMN | Public Land Mobile Network |
| RAN | Radio Access Network |
| RAT | Radio Access Technology |
| RLC | Radio Link Control |
| RRC | Radio Resource Control |
| RRH | Remote Radio Head |
| SMBR | Slice Maximum Bit Rate |
| UE | User Equipment |
| UI | User Interface |
| UP | User Plane |
| WCDMA | Wideband Code Division Multiple Access |

REFERENCE SIGNS LIST

| | |
|---|---|
| 110 | User Equipment |
| 115 | Air interface |
| 120 | Base station |
| 125, 135 | Wired interfaces |
| 130 | Core network |
| 210 | Distributed unit |
| 220 | Central unit control plane |
| 230, 235 | Central unit user plane |
| 310-370 | Phases of the signaling graph of FIG. 3 |
| 400-450 | Structure of the apparatus of FIG. 4 |
| 510-530 | Phases of the first method in FIG. 5 |
| 610-630 | Phases of the second method in FIG. 6 |

1.-15. (canceled)

16. An apparatus, comprising:
means for transmitting, to a distributed unit, a first request to restrict uplink traffic of a slice for a user equipment;
means for receiving from the distributed unit a notification indicating a failure in restricting the uplink traffic of the slice for the user equipment according to the first request; and
means for transmitting, responsive to said reception, a second request to restrict the uplink traffic of the slice for the user equipment to at least one central unit user plane.

17. The apparatus according to claim 16, wherein the first request and/or the second request comprises an uplink maximum bit rate value of the slice for the user equipment.

18. The apparatus according to claim 17, wherein the uplink maximum bit rate value is an upper bound bit rate for all traffic of all radio bearers associated to protocol data unit sessions active for the slice for the user equipment.

19. The apparatus according to claim 17, wherein the uplink maximum bit rate value of the slice for the user equipment is transmitted in an F1 application protocol user equipment context setup or modification message.

20. The apparatus according to claim 16, wherein the notification indicating a failure in restricting the uplink traffic of the slice for the user equipment is received in an F1 application protocol notify message.

21. The apparatus according to claim 16, wherein the notification indicating a failure in restricting the uplink traffic of the slice for the user equipment is received in an F1 application protocol response message responsive to the first request.

22. The apparatus according to claim 21 wherein the F1 application protocol response message is an F1 application protocol user equipment context setup or modification response message.

23. The apparatus according to claim 16, wherein the second request is transmitted in an E1 application protocol notify message.

24. The apparatus according to claim 16, wherein the second request is transmitted in a new dedicated E1 application protocol message.

25. The apparatus according to claim 16, wherein the first request is transmitted in an F1 application protocol message.

26. The apparatus according to 16, wherein the second request to restrict the uplink traffic of the slice for the user equipment comprises an indication indicating a failure in restricting the uplink traffic of the slice for the user equipment in the distributed unit according to the first request.

27. The apparatus according to claim 16, wherein the second request is transmitted to multiple central unit user planes, and the apparatus further comprises:
means for transmitting to each of said multiple central unit user planes the second request to restrict uplink traffic of the slice for the user equipment to a share of an uplink maximum bit rate value of the slice for the user equipment, the share being a share of an uplink maximum bit rate value of the slice for the user equipment requested from the distributed unit.

28. The apparatus, comprising:
means for receiving, from a central unit control plane, a first request to restrict uplink traffic of a slice for a user equipment;
means for detecting that the apparatus fails to restrict the uplink traffic of the slice for the user equipment according to the first request; and
means for transmitting to the central unit control plane, upon said detection, a notification indicating a failure in restricting the uplink traffic of the slice for the user equipment according to the first request.

29. The apparatus according to claim 28, wherein said means for detecting further comprises means for detecting that the apparatus fails to restrict uplink traffic of the slice for the user equipment according to an uplink maximum bit rate value of the slice for the user equipment.

30. The apparatus according to claim 28, wherein said means for detecting further comprises detecting that the apparatus is unable to apply logical channel restrictions or logical channel group configurations associated with the radio bearers of the slice.
